(19) United States
(12) Patent Application Publication
(10) Pub. No.: US 2017/0314423 A1
(43) Pub. Date: Nov. 2, 2017

(54) COMBINED CYCLE POWER PLANT WITH ABSORPTION REFRIGERATION SYSTEM

(71) Applicant: Siemens Aktiengesellschaft, München (DE)

(72) Inventor: Shivprasad Dinkar, Oviedo, FL (US)

(21) Appl. No.: 15/517,281

(22) PCT Filed: Oct. 28, 2014
(86) PCT No.: PCT/US2014/062530

§ 371 Date: Apr. 6, 2017

(51) Int. Cl. F01K 23/18; F02C 6/18; F02C 7/12; F25B 27/02; F25B 15/04

(52) U.S. Cl. CPC F01K 23/18; F02C 7/12; F25B 27/02; F02C 6/18; F25B 15/04; F05D 2260/207

(57) ABSTRACT

The present disclosure provides a combined cycle power plant (10) comprising a gas turbine (26), a heat-recovery steam generator (34) receiving exhaust gas (33) from the gas turbine (26) for producing steam (35), a steam turbine (32) receiving and expanding the steam (35) from the heat-recovery steam generator (34) to produce expanded steam (36), an air-cooled condenser (50) receiving the expanded steam (36) from the steam turbine (32), and an absorption refrigeration system (40) receiving a reduced temperature exhaust gas (38) from the heat-recovery steam generator (34). The absorption refrigeration system (40) is connected to the air-cooled condenser (50) to selectively extract heat from air (55) entering the air-cooled condenser (50).

### FIELD OF THE INVENTION

The present disclosure relates generally to generation of electric power, and more particularly to a combined cycle power plant including an absorption refrigeration system.

### BACKGROUND OF THE INVENTION

Combined cycle power plants typically include a gas turbine that is powered by the combustion of a fuel and one or more steam turbines that are driven by waste heat recovered from the exhaust of the gas turbine engine. The gas portion, or topping cycle, operates as a Brayton cycle, and the steam portion, or bottoming cycle, operates as a Rankine cycle in which the steam turbine is powered by steam that is generated by the cooling of the gas turbine exhaust in a heat-recovery steam generator (HRSG). This setup allows the waste heat from the topping cycle to be recovered and used in the bottoming cycle to generate energy. The expanded steam exhausted from the steam turbine is fed into an air-cooled condenser (ACC), which converts the expanded steam into condensate via evaporative cooling. The condensate is then returned to the HRSG for reuse.

Steam from the HRSG sometimes bypasses the steam turbine and is routed straight to the ACC, particularly during plant startup and during a steam turbine trip, which frequently overloads the ACC. Because the ACC performance depends largely on the initial temperature difference (ITD) between the ambient air and the expanded steam fed into the ACC, these problems are intensified on hot days. One typical solution to meet these increased heat transfer demands involves increasing the size of the ACC. However, this approach significantly increases the cost of the ACC, often with insufficient improvement in combined cycle efficiency to justify the increased cost.

### SUMMARY OF THE INVENTION

In accordance with one aspect of the invention, the present disclosure provides a combined cycle power plant comprising a gas turbine, a heat-recovery steam generator receiving exhaust gas from the gas turbine for producing steam, a steam turbine receiving and expanding the steam from the heat-recovery steam generator to produce expanded steam, an air-cooled condenser receiving the expanded steam from the steam turbine, and an absorption refrigeration system receiving a reduced temperature exhaust gas from the heat-recovery steam generator. The absorption refrigeration system is connected to the air-cooled condenser to selectively extract heat from air entering the air-cooled condenser.

In accordance with some aspects, the absorption refrigeration system includes an evaporator that is positioned across an air inlet for the air-cooled condenser. In accordance with other aspects, the absorption refrigeration system includes a generator receiving the reduced temperature exhaust gas from the heat-recovery steam generator to drive an absorption refrigeration cycle. In accordance with additional aspects, the heat-recovery steam generator receives a condensate from the air-cooled condenser for production of the steam. In accordance with further aspects, Q_{E}=Q_{HD}−Q_{AV}, where Q_{AV} is a cooling requirement of the expanded steam from the steam turbine under average operating conditions, Q_{HD} is a cooling requirement of the expanded steam from the steam turbine under a maximum high duty condition for the combined cycle power plant, and Q_{E} is a cooling capacity of the absorption refrigeration system.

In accordance with another aspect of the invention, the present disclosure provides a combined cycle power plant comprising a gas turbine, a heat-recovery steam generator receiving exhaust gas from the gas turbine for producing steam from a supply of water, a steam turbine receiving and expanding the steam from the heat-recovery steam generator to produce expanded steam, an air-cooled condenser receiving the expanded steam from the steam turbine and producing a condensate, and an absorption refrigeration system connected to the heat-recovery steam generator and the air-cooled condenser. The absorption refrigeration system includes a generator receiving a reduced temperature exhaust gas from the heat-recovery steam generator to drive an absorption refrigeration cycle and an evaporator that is positioned across an air inlet for the air-cooled condenser to selectively extract heat from air entering the air-cooled condenser to effect a pre-cooling of air entering the air-cooled condenser. In accordance with some aspects, the condensate produced by the air-cooled condenser provides the supply of water to the heat-recovery steam generator for production of the steam.

In accordance with further aspects of the invention, the present disclosure provides a method of operating a combined cycle power plant. The method includes the steps of producing power from a gas turbine, conveying exhaust gas from the gas turbine to a heat-recovery steam generator for producing steam and producing a reduced temperature exhaust gas, expanding the steam from the heat-recovery steam generator in a steam turbine to produce power, condensing the expanded steam from the steam turbine in an air-cooled condenser and producing condensate, driving a generator of an absorption refrigeration cycle with the reduced temperature exhaust gas exiting the heat-recovery steam generator to produce a cooling fluid, selectively conveying the cooling fluid to an evaporator of the absorption refrigeration cycle that is positioned across an air inlet to the air-cooled condenser, and passing air through the evaporator to selectively extract heat from the air entering the air inlet of the air-cooled condenser to effect a pre-cooling of the air provided to the air-cooled condenser.

In some aspects of the method, Q_{E}=Q_{HD}−Q_{AV}, where Q_{AV} is a cooling requirement of the expanded steam from the steam turbine under average operating conditions, Q_{HD} is a cooling requirement of the expanded steam from the steam turbine under a maximum high duty condition for the power plant, and Q_{E} is a cooling capacity of the absorption refrigeration system. In other aspects, the method further comprises selectively operating the combined cycle power plant without cooling from the evaporator. In a particular aspect, Q_{CUR} is a cooling requirement of the expanded steam from the steam turbine under a current operating condition, and cooling fluid is conveyed to the evaporator of the absorption refrigeration cycle only when Q_{CUR}>Q_{AV}.

### BRIEF DESCRIPTION OF THE DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 is a simplified schematic of a combined cycle power plant including an absorption refrigeration system in accordance with aspects of the invention;

FIG. 2 is a flowchart illustrating a method of operating a combined cycle power plant in accordance with aspects of the invention; and

FIG. 3 is a flowchart illustrating another method of operating a combined cycle power plant in accordance with other aspects of the invention.

### DETAILED DESCRIPTION OF THE INVENTION

In the following detailed description of the preferred embodiment, reference is made to the accompanying drawings that form a part hereof, and in which is shown by way of illustration, and not by way of limitation, a specific preferred embodiment in which the invention may be practiced. It is to be understood that other embodiments may be utilized and that changes may be made without departing from the spirit and scope of the present invention.

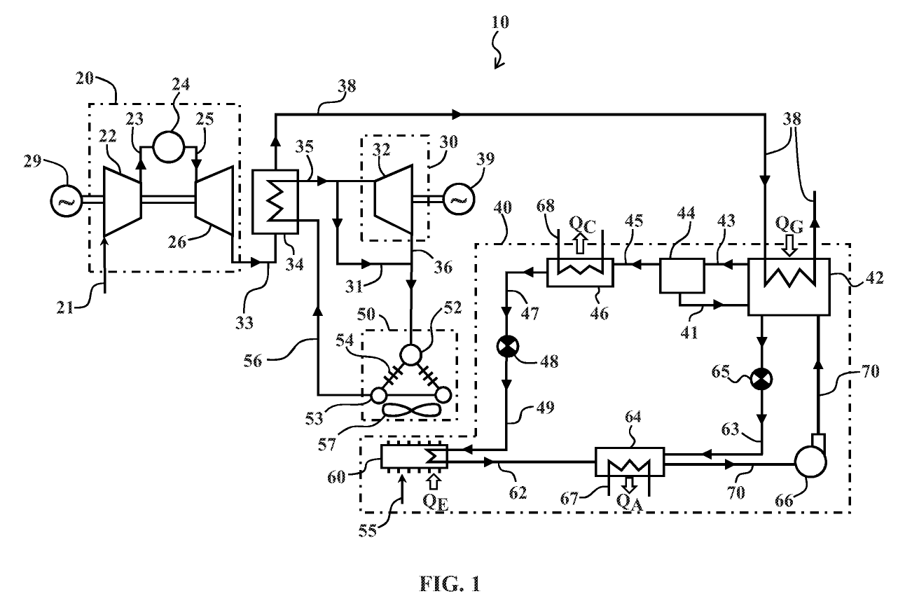

FIG. 1 is a simplified schematic illustrating a combined cycle power plant 10 embodying aspects of the invention. The power plant 10 comprises a gas turbine system 20, a steam turbine system 30, an absorption refrigeration system 40, and an air-cooled condenser system 50. The gas turbine system 20 may comprise any suitable design and may include, for example, a compressor 22, a combustion chamber 24, and a gas turbine 26. The compressor 22 receives an ambient airflow 21 and produces a flow of compressed air 23, which is supplied to the combustion chamber 24. Fuel combined with the compressed air 23 is combusted in the combustion chamber 24 to produce hot combustion gases 25 that flow to the gas turbine 26. The hot combustion gases 25 are expanded in the gas turbine 26 to produce energy that drives a shaft, which in turn drives a first electrical generator 29 to produce electricity.

Exhaust gas 33 exits the gas turbine 26 and enters a heat-recovery steam generator (HRSG) 34. The HRSG 34 acts as a heat exchanger to remove a portion of the heat from the exhaust gas 33. The heat removed from the exhaust gas 33 is used to generate steam 35 from a supply of water, which is directed to the steam turbine system 30. A reduced temperature exhaust gas 38 exiting the HRSG 34 is directed to the absorption refrigeration system 40, which is described in more detail below. A bypass circuit 31 may optionally be used as needed to feed some or all of the steam 35 generated by the HRSG 34 directly to the ACC 50, which is also described in more detail below. A steam turbine 32 expands the steam 35 received from the HRSG 34 to produce energy that drives a shaft, which drives a second electrical generator 39 to produce electricity. Expanded steam 36 exiting the steam turbine 32 is fed into the ACC 50.

The ACC 50 may comprise any suitable conventional design. In the simplified embodiment shown in FIG. 1, the ACC 50 is an A-frame design. A vapor inlet header 52 receives the expanded steam 36 exiting the steam turbine 32. Cooling bundles 54 extend downwardly from the vapor inlet header 52 and receive the expanded steam 36 from the vapor inlet header 52. The cooling bundles 54 typically comprise a tube with a plurality of fins along which the expanded steam 36 flows and condenses to form a condensate 56 comprising liquid water. An incoming airflow 55 is drawn into the ACC 50 by a fan 57 and flows across the cooling bundles 54 to cool the expanded steam 54 flowing along the cooling bundles 54. In some aspects of the invention, the cooling bundles 54 may each comprise a parallel flow condenser in which the expanded steam 36 and the condensate 56 forming inside the tubes flow together in the same direction along the length of the outlet header 54. The condensate 56 collects in one or more collection headers 53 located at the bottom of the ACC 50. The condensate 56 is then directed to the HRSG 34 for reuse.

The reduced temperature exhaust gas 38 exiting the HRSG 34 may be received by the absorption refrigeration system 40. The absorption refrigeration system 40 may comprise any suitable closed refrigeration cycle. In the exemplary embodiment shown in FIG. 1, an ammonia-water absorption refrigeration system is depicted, but it is noted that other suitable cycles and systems may be utilized, including a lithium bromide/water absorption refrigeration system. In FIG. 1, a generator 42 contains a strong solution of ammonia, NH₃, absorbed into water and pumped to a high pressure. The strong NH₃—H₂O solution absorbs heat Q_{G} from the reduced temperature exhaust gas 38 received by the generator 42, generating a vapor 43 that collects at the top of the generator 42. Ammonia's low boiling point (−28° F.) makes it ideally suited for use with sources of low quality waste heat such as the reduced temperature exhaust gas 38 exiting the HRSG 34. Following vaporization of the NH₃, a weak NH₃—H₂O solution remains in the generator 42. The reduced temperature exhaust gas 38 exiting the generator 42 may be vented to the atmosphere or it may be directed to another component of the combined cycle power plant 10 for reuse.

The vapor 43 contains mainly NH₃, but because of water's high affinity for NH₃, some water is typically present in the vapor 43. To remove the water, the vapor 43 is fed into a rectifier 44, where the vapor 43 is cooled slightly. Water contained in the vapor 43 condenses, leaving a pure NH₃ vapor 45 that is then directed to a condenser 46. A small amount of NH₃ condenses in the rectifier 44 along with the water, leaving a weak NH₃—H₂O solution in the rectifier. A solution 41 comprising a combination of the weak NH₃—H₂O solution and the water condensed out of the vapor 43 is directed from the rectifier 44 back into the generator 42, where the solution 41 joins the weak NH₃—H₂O solution generated by vaporization of NH₃ from the strong NH₃—H₂O solution.

The pure NH₃ vapor 45 enters the condenser 46 at a high pressure. Inside the condenser 46, the pure NH₃ vapor 45 condenses to form liquid NH₃ 47 and releases heat Q_{C}. The condenser 46 typically comprises a condenser cooling circuit 68 that helps to cool the pure NH₃ vapor 45. The condenser cooling circuit 68 may use, for example, water or other suitable cooling fluid, including a portion of the NH₃ refrigerant created by the absorption refrigeration system 40. The liquid NH₃ 47 is then passed through an expansion valve 48 where the pressure and temperature of the liquid NH₃ refrigerant 47 are further reduced. A low pressure, chilled NH₃ refrigerant 49 exits the expansion valve 48 and is directed to an evaporator 60.

The evaporator 60 is connected to the ACC 50, and in some aspects of the invention, the evaporator 60 may be positioned across an air inlet (not labeled) of the ACC 50 through which the incoming airflow 55 is drawn into the ACC 50. The NH₃ refrigerant 49 circulates through the evaporator 60 where the NH₃ refrigerant 49 absorbs heat Q_{E} from the incoming airflow 55 to effect a pre-cooling of the incoming airflow 55 prior to entering the ACC 50 and flowing across the outlet headers 54. The absorption of heat Q_{E} from the incoming airflow 55 by the NH₃ refrigerant 49 vaporizes the NH₃ refrigerant 49 to form gaseous NH₃ 62.

The gaseous NH₃ 62 from the evaporator 60 is then fed to an absorber 64. A weak NH₃—H₂O solution 63 present in the generator 42 passes through a second expansion valve 65 before it is also fed into the absorber 64. This NH₃—H₂O solution 63 comprises the weak NH₃—H₂O solution generated by vaporization of NH₃ from the strong NH₃—H₂O solution plus the solution 41 from the rectifier 44. The weak NH₃—H₂O 63 solution in the absorber 64 is unsaturated and readily absorbs the gaseous NH₃ 62 being fed from the evaporator 60 to regenerate a strong NH₃—H₂O solution 70. The process of regenerating the strong NH₃—H₂O solution 70 generates heat Q_{A}, so the absorber 64 typically includes a cooling circuit 67 that utilizes water or other suitable cooling fluid. The strong NH₃—H₂O solution 70 is directed to a pump 66, where the strong NH₃—H₂O solution 70 is pumped to high pressure and fed into the generator 42 to repeat the cycle.

The presently disclosed systems and methods may be used to increase the capacity of the ACC without an accompanying increase in size. The size and design of the ACC is dictated by a variety of parameters, including the location of the combined cycle power plant and the climate in which it operates, the type of fuel used by the gas turbine system, etc. When the ambient air temperature is already high, the initial temperature difference (ITD), which is the difference between the temperature of the incoming airflow and the temperature of the expanded steam fed into the ACC, is decreased. A lower ITD reduces the heat transfer capacity and effectiveness of the ACC. This decreased capacity may be of particular importance when the combined cycle power plant is under high duty conditions, such as plant startup or during a steam turbine trip. In these situations, the steam from the HRSG may exceed the ability of the steam turbine system to utilize the available steam, requiring that the steam turbine system be partially or completely bypassed via the bypass circuit 31. In that case, the steam is fed directly into the ACC, which can quickly overwhelm the ACC's cooling capacity.

To provide sufficient cooling, an oversize ACC is used in most conventional combined cycle power plants to handle the higher loads. However, these larger ACC designs are costly and provide little flexibility when less cooling is needed. For example, on cool days when the ITD is already quite large, operation of the ACC is reduced or discontinued to prevent freezing, particularly where the ACC is oversized. By effecting pre-cooling of the incoming airflow entering the ACC, the presently disclosed invention may be used to increase the ITD and increase the ACC's cooling capacity without the need to increase the size of the ACC. Viewed alternatively, the present invention permits use of an ACC having a size that is reduced relative to typical ACC designs having similar cooling requirements for a given maximum steam heat load.

For example, a combined cycle power plant in accordance with one aspect of the invention may include an ACC designed to provide only the amount of cooling required during typical or average plant operation. It may understood that “average plant operation” as used herein refers to plant operating conditions that include operation at ambient temperatures that are at a median between maximum and minimum predicted ambient temperatures for a given plant location, as well as at base load conditions that are below a maximum or high load and can be above part load conditions. The absorption refrigeration system may be used to pre-cool the incoming airflow entering the ACC only when necessary i.e. when the ITD is low and/or during high duty conditions. The absorption refrigeration system may be turned off when the existing ACC cooling capacity is sufficient or excessive, such as when the ambient temperature is low. In this way, the ACC size and cooling capacity may be more closely tailored to the actual cooling requirements of the combined cycle power plant during a variety of operating conditions.

Where the combined cycle power plant is under high duty conditions, a cooling capacity of the ACC is Q_{HD}−nQ_{HD}, in which Q_{HD} is a maximum cooling requirement of the expanded steam from the steam turbine under high duty conditions for the power plant, n is a reduction factor in which 0<n<1.0, and a cooling capacity of the absorption refrigeration system is at least nQ_{HD}. Alternatively, the additional cooling capacity required of the absorption refrigeration system Q_{E} (FIG. 1) may be expressed as Q_{HD}−Q_{AV}, in which Q_{AV} is the designed cooling capacity of the ACC based on average operating conditions. In some aspects of the invention, Q_{CUR} is a current cooling requirement of the expanded steam from the steam turbine under a current operating condition, and the absorption refrigeration system may be periodically engaged to provide additional cooling only when Q_{CUR} exceeds Q_{AV}. Q_{CUR} may comprise a range from zero up to and including Q_{HD}.

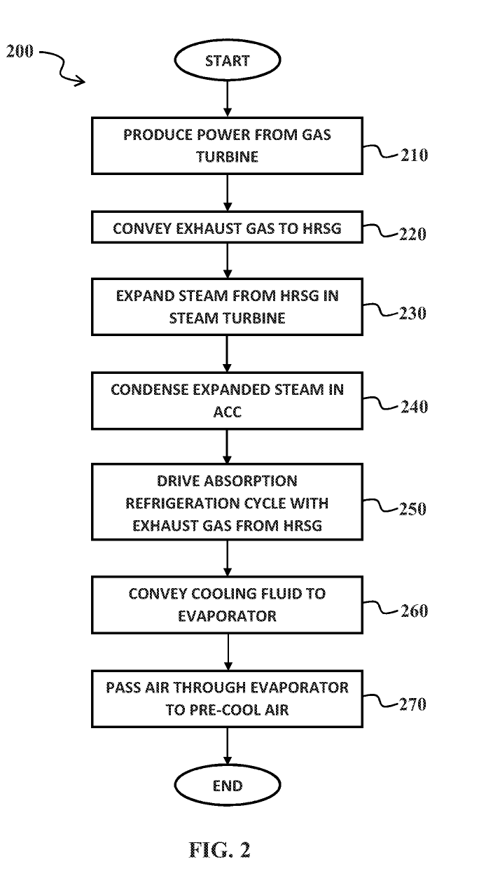

The present invention further provides methods of operating a combined cycle power plant. FIG. 2 is a flowchart illustrating a method 200 according to one aspect of the invention. The method 200 begins with producing power from a gas turbine (step 210). As described herein, fuel is combined with compressed air in a combustion chamber to produce hot combustion gases that are expanded in the gas turbine to produce energy that drives a shaft. The shaft drives an electrical generator to produce electrical power. In the next step, exhaust gas from the gas turbine is conveyed to a heat-recovery steam generator for producing steam and producing a reduced temperature exhaust gas (step 220). A steam turbine expands the steam received from the heat-recovery steam generator to produce electrical power (step 230).

The method 200 continues with condensing the expanded steam from the steam turbine in an air-cooled condenser and producing condensate (step 240). A reduced temperature exhaust gas exiting the heat-recovery steam generator is used to drive the generator of an absorption refrigeration system to produce a cooling fluid (step 250). As described herein, the cooling fluid may comprise an NH₃ refrigerant. The cooling fluid is then selectively conveyed to an evaporator of the absorption refrigeration system (step 260). The evaporator is positioned across an air inlet to the air-cooled condenser. The method 200 concludes with passing air through the evaporator to selectively extract heat from the air as it enters the air inlet of the air-cooled condenser, thereby effecting a pre-cooling of the air provided to the air-cooled condenser (step 270).

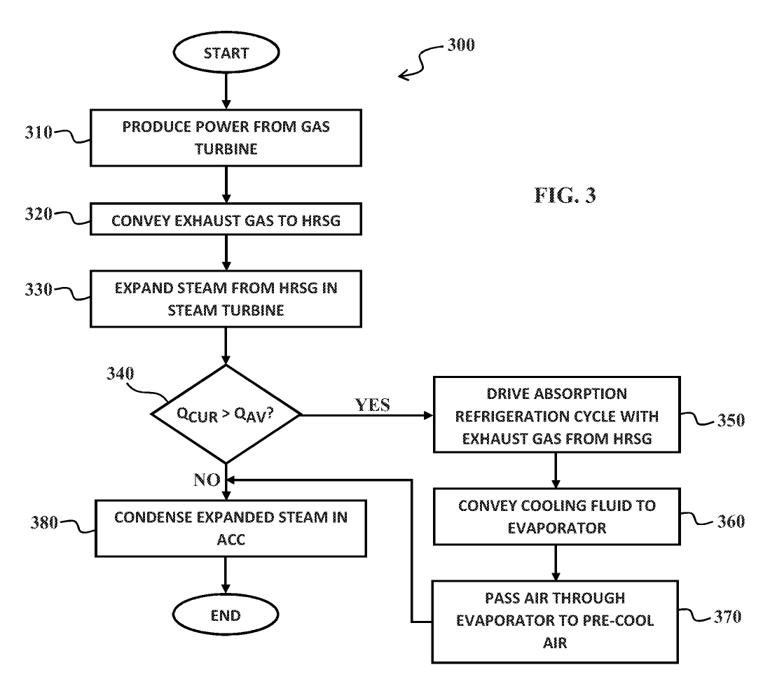

FIG. 3 is a flowchart illustrating a method 300 according to another aspect of the invention. Similar to method 200 illustrated in FIG. 2, the method 300 begins with producing power from a gas turbine (step 310) and conveying exhaust gas from the gas turbine to a heat-recovery steam generator for producing steam and producing a reduced temperature exhaust gas (step 320). A steam turbine expands the steam received from the heat-recovery steam generator to produce electrical power (step 330). A determination is then made whether to engage the absorption refrigeration cycle. For example, in step 340, a determination is made as to whether Q_{CUR}, which is the cooling requirement of the expanded steam from the steam turbine under a current condition, is greater than Q_{AV}, which is the cooling capacity based on the cooling requirements of the combined cycle power plant operating on a typical or average day. Where Q_{CUR}≦Q_{AV}, the method 300 concludes with condensing the expanded steam from the steam turbine in the ACC (step 280).

Where Q_{CUR}>Q_{AV}, a reduced temperature exhaust gas exiting the heat-recovery steam generator is used to drive the generator of an absorption refrigeration system to produce a cooling fluid (step 350). The cooling fluid is then conveyed to an evaporator of the absorption refrigeration system (step 360), which is positioned across an air inlet to the air-cooled condenser. Heat is extracted from the air flowing into the air inlet of the ACC to effect a pre-cooling of the air provided to the ACC (step 370). In this way, the absorption refrigeration system provides an additional cooling capacity Q_{E} (FIG. 1) such that Q_{E}≧Q_{CUR}−Q_{AV}. Q_{CUR} may comprise a range of cooling requirements from zero up to and including Q_{HD}, and in some aspects of the method, Q_{CUR} may equal Q_{HD} such that Q_{E}≧Q_{HD}−Q_{AV}. The method concludes with condensing the expanded steam from the steam turbine in the ACC (step 380). In this particular aspect of the method, the absorption refrigeration system may be operated to convey cooling fluid to the evaporator of the absorption refrigeration system only when Q_{CUR}>Q_{AV}.

From the above description, it may be understood that in accordance with aspects of the present invention, a reduced size ACC may be provided, with any associated reduction in cooling being offset by the absorption refrigeration system. In addition, under operating conditions in which the ACC is capable of providing excess cooling, such as on low ambient temperature days requiring adjustment of steam flow to reduce cooling applied by the ACC, the reduction in ACC size provided by the present invention may allow the control or adjustment of flow in the ACC to be minimized over the range of operation of the steam portion of the power plant.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A combined cycle power plant comprising:
a gas turbine;
a heat-recovery steam generator receiving exhaust gas from the gas turbine for producing steam;
a steam turbine receiving and expanding the steam from the heat-recovery steam generator, wherein the steam turbine produces expanded steam;
an air-cooled condenser receiving the expanded steam from the steam turbine; and
an absorption refrigeration system receiving a reduced temperature exhaust gas from the heat-recovery steam generator, wherein the absorption refrigeration system is connected to the air-cooled condenser to selectively extract heat from air entering the air-cooled condenser.

2. The combined cycle power plant of claim 1, wherein the absorption refrigeration system includes an evaporator that is positioned across an air inlet for the air-cooled condenser.

3. The combined cycle power plant of claim 1, wherein the absorption refrigeration system includes a generator receiving the reduced temperature exhaust gas from the heat-recovery steam generator to drive an absorption refrigeration cycle.

4. The combined cycle power plant of claim 1, wherein the heat-recovery steam generator receives a condensate from the air-cooled condenser for production of the steam.

5. The combined cycle power plant of claim 1, wherein Q_{E}=Q_{HD}−Q_{AV} where Q_{AV} is a cooling requirement of the expanded steam from the steam turbine under average operating conditions, Q_{HD} is a cooling requirement of the expanded steam from the steam turbine under a maximum high duty condition for the combined cycle power plant, and Q_{E} is a cooling capacity of the absorption refrigeration system.

6. A combined cycle power plant comprising:
a gas turbine;
a heat-recovery steam generator receiving exhaust gas from the gas turbine for producing steam from a supply of water;
a steam turbine receiving and expanding the steam from the heat-recovery steam generator, wherein the steam turbine produces expanded steam;
an air-cooled condenser receiving the expanded steam from the steam turbine and producing a condensate; and
an absorption refrigeration system connected to the heat-recovery steam generator and the air-cooled condenser, the absorption refrigeration system including:
a generator receiving a reduced temperature exhaust gas from the heat-recovery steam generator to drive an absorption refrigeration cycle; and
an evaporator that is positioned across an air inlet for the air-cooled condenser to selectively extract heat from air entering the air-cooled condenser to effect a pre-cooling of air entering the air-cooled condenser.

7. The combined cycle power plant of claim 6, wherein the condensate produced by the air-cooled condenser provides the supply of water to the heat-recovery steam generator for production of the steam.

8. A method of operating a combined cycle power plant, the method including:
producing power from a gas turbine;
conveying exhaust gas from the gas turbine to a heat-recovery steam generator for producing steam and producing a reduced temperature exhaust gas;
expanding the steam from the heat-recovery steam generator in a steam turbine to produce power;
condensing the expanded steam from the steam turbine in an air-cooled condenser and producing condensate;
driving a generator of an absorption refrigeration cycle with the reduced temperature exhaust gas exiting the heat-recovery steam generator to produce a cooling fluid;
selectively conveying the cooling fluid to an evaporator of the absorption refrigeration cycle, wherein the evaporator is positioned across an air inlet to the air-cooled condenser; and
passing air through the evaporator to selectively extract heat from the air entering the air inlet of the air-cooled condenser to effect a pre-cooling of the air provided to the air-cooled condenser.

9. The method of claim 8, wherein Q_{E}=Q_{HD}−Q_{AV}, where Q_{AV} is a cooling requirement of the expanded steam from the steam turbine under average operating conditions, Q_{HD} is a cooling requirement of the expanded steam from the steam turbine under a maximum high duty condition for the power plant, and Q_{E} is a cooling capacity of the absorption refrigeration system.

10. The method of claim 8, further comprising selectively operating the combined cycle power plant without cooling from the evaporator.

11. The method of claim 10, wherein Q_{CUR} is a cooling requirement of the expanded steam from the steam turbine under a current operating condition and wherein cooling fluid is conveyed to the evaporator of the absorption refrigeration cycle only when Q_{CUR}>Q_{AV}.
